(19) United States
(12) Patent Application Publication
(10) Pub. No.: US 2025/0067296 A1
(43) Pub. Date: Feb. 27, 2025

(54) Panel Connecting Device

(71) Applicant: Wayne Mortimer, Weymouth (GB)

(72) Inventor: Wayne Mortimer, Weymouth (GB)

(21) Appl. No.: 18/727,011

(22) PCT Filed: Jul. 1, 2023
(86) PCT No.: PCT/GB2023/050025

§ 371 Date: Jul. 5, 2024

(30) Foreign Application Priority Data
Jul. 1, 2022 (GB) 2200162.2

(51) Int. Cl. F16B 12/26

(52) U.S. Cl. CPC F16B 12/26

(57) ABSTRACT

An exemplary panel connecting system includes an elongate structural profile and two alignment means abutting opposite ends of the structural profile. The structural profile includes a main body and two elongate, elastically deformable tenons extending from the main body. Typically, the tenons are perpendicular to each other. Each tenon is bifurcated, thereby defining a pair of elongate prongs. Each prong has a stem portion and an enlarged distal end barb. The prongs are elastically deformable towards each other and thereby snappingly engaged in a matching channel of a corresponding panel. Each alignment means includes a pair of plugs, each of which is interferingly engaged in a matching hole of a corresponding panel. The structural profile also includes a slot channel, whereby it is attachable to another contiguous structural profile by an interlocking means when needed.

### INTRODUCTION AND BACKGROUND OF INVENTION

The present invention is related to systems that simplify the production and erection of self assembly articles such as furniture panels of various sizes.

When connecting self assembly furniture panels to form an article of furniture, knock-down fittings are typically used. Knock-down fittings are devices that interconnect panels, and are installed with simple tools, typically a screwdriver and hammer. The most common knock-down device system is a cam dowel and lock system.

However, using traditional knock-down fittings in self assembly furniture can lead to a number of problems during both manufacture and assembly. Manufacture requires complex and labour intensive machinery in order to accurately produce and align different parts across multiple axes. Assembly is often slow, requiring instruction booklets and many different small parts that can easily be misplaced. Furthermore, the knock-down fittings typically generate small concentrated load bearing areas that make the panels vulnerable to breakage during assembly. These issues can lead to delay in completing an installation, additional cost to rectify, and frustration for people.

To overcome these problems, the present invention proposes the use of an elongate structural profile connecting system, to evenly distribute the mechanical load on furniture panels and simplify the self assembly process. In one embodiment, the present furniture panel connecting system seeks to achieve this by utilizing a structural profile with a connecting means interfacing with an undercut channel of a panel, and an alignment means interfacing with a cutout of the panel perpendicular to the channel to align, guide and restrict the structural profile in position.

Furthermore, in the case of more complicated furniture assemblies, the present furniture panel connecting system utilizes a slot channel in the structural profile, which together with an interlocking means is used to interlock adjacent structural profiles of two adjoining articles of furniture.

### SUMMARY OF INVENTION

The present elongate structural profile interconnects two panels for example. The structural profile has a main body; and adopts two or more connecting means extending from the main body and positioned at right angles to one another. Typically, the main body has a first transverse width congruent with the thickness of a first mating panel. The main body also has a second transverse width perpendicular to the first width. Typically, the second transverse width is congruent with the thickness of a second mating panel.

In alternative embodiments, overall first and second transverse widths of the main body are greater than the thicknesses of the first and second mating panels. However, planar faces of two sides of the main body abutting the mating panels are congruent in width with the thicknesses of the panels. Accordingly, the main body has an elongate chamfer located between the mating panels. The chamfer can be a planar chamfer or a curved, concave chamfer, for example.

Each connecting means of the structural profile is typically in the form of a mechanical clip, capable of fittingly engaging in an undercut channel of a mating panel. Typically, the mechanical clip is bifurcated, thereby defining two elongate prongs. The prongs are elastically deformable, and are typically symmetrical. Thus the mechanical clip can be snappingly engaged in the undercut channel. Alternatively, the mechanical clip is asymmetrical in form.

In alternative embodiments, the connecting means is in the form of two wings extending from a stem portion, with distal ends of the wings engaging with shoulders of the undercut channel.

Typically, the structural profile is held in position by a pair of alignment means. Each alignment means is preferably in the form of a bracket. The bracket is typically L-shaped, with cylindrical plugs capable of engaging with the two adjoining panels. Such bracket can also be engaged with the structural profile using a fastener such as a screw.

Furthermore, the main body of the structural profile preferably includes one or more slot channels that allow interlocking with an adjacent structural profile when needed. Such interlocking is achieved using interlocking means, which are engaged in the slot channels of two or more adjacent structural profiles. Thereby, the interlocking means can connect multiple structural profiles together.

The slot channels also enable the structural profile to engage directly or indirectly with additional elements such as furniture feet, wall brackets or structural support pieces when needed.

In other embodiments, the alignment means is configured to enable attachment of a handleless profile or a wall bracket thereto.

In some embodiments, the alignment means not only engages with one or more adjoining panels, but also serves as interlocking means connecting two, three or four structural profiles together.

In another embodiment, the alignment means is a bracket with no cylindrical plugs. Such bracket instead has one or more other plugs that are engaged in the structural profile.

In a further embodiment, the alignment means is in the form of a strip of material attached along an edge face of a panel. The strip of material covers an end of an undercut channel of the panel, thereby preventing displacement of a structural profile engaged in the undercut channel.

### BRIEF DESCRIPTION OF DRAWINGS

Embodiments of the present furniture panel connecting system will be described below solely by way of example and with reference to the accompanying drawings.

FIG. 1 shows a perspective view of plural example furniture panel connecting systems of one embodiment of the present invention used to form a cabinet, each furniture panel connecting system including a structural profile.

FIG. 2 shows an enlarged, exploded view of the top, right-side front corner of the cabinet of FIG. 1.

FIG. 3 shows an enlarged, exploded view of the top, left-side rear corner of the cabinet of FIG. 1.

FIG. 4 shows an enlarged, exploded view of the top, right-side front corner of a cabinet, which is formed by plural example furniture panel connecting systems of another embodiment of the present invention.

FIG. 5 shows an enlarged, exploded perspective view of two cabinets interconnecting by utilising an example furniture panel connecting system of the present invention, the system including two structural profiles and two interlocking clips.

FIG. 6 shows an end plan view of one of the interlocking clips of FIG. 5 joining the two structural profiles together.

FIG. 7 shows an isometric view of a generally H-shaped block, which can be used to join two structural profiles together according to an embodiment of the present invention.

FIG. 8 shows end plan views of H-shaped blocks of FIG. 7 used to join two structural profiles together, and used to join three structural profiles together, according to embodiments of the present invention.

FIG. 9 shows an enlarged, exploded view of two cabinets interconnecting utilising an example furniture panel connecting system of the present invention, the system including an interlocking clipping block having an adjustable furniture foot attached thereto.

FIG. 10 shows an enlarged, exploded view of two cabinets interconnecting utilising an example furniture panel connecting system of the present invention, the system including an end bracket, and the end bracket being adapted to have a handleless profile attached thereto.

FIG. 11 shows an enlarged, exploded view of two cabinets interconnecting utilising an example furniture panel connecting system of the present invention, the system including an end bracket, and the end bracket being adapted to have a wall plate attached thereto.

FIG. 12 shows a perspective view of plural example furniture panel connecting systems of another embodiment of the present invention used to form a cabinet.

FIG. 13 shows an enlarged, exploded view of parts of two adjacent panels of the cabinet of FIG. 12, including a structural profile.

FIG. 14 shows a perspective view of a furniture panel connector according to an alternative embodiment of the present invention.

FIG. 15 shows a perspective view of the furniture panel connector of FIG. 14, but viewed from an underside thereof.

FIG. 16 shows a transverse cross-sectional view of a structural profile portion of the furniture panel connector of FIG. 14.

FIG. 17 shows a perspective view of a furniture panel connector according to an alternative embodiment of the present invention.

FIG. 18 shows another perspective view of the furniture panel connector of FIG. 17.

FIG. 19 shows a transverse cross-sectional view of a structural profile portion of a furniture panel connector in accordance with another alternative embodiment of the present invention.

FIG. 20 shows a cross-sectional view of the connector of FIG. 19 interconnecting a side panel and a top panel.

FIG. 21 shows a cross-sectional view of two panels joined together by a furniture panel connector in accordance with an alternative embodiment of the present invention.

FIG. 22 shows a cross-sectional view of two panels joined together by a furniture panel connector in accordance with another alternative embodiment of the present invention.

FIG. 23 shows a transverse cross-sectional view of a structural profile with a slot channel in accordance with an alternative embodiment of the present invention.

FIG. 24 shows a cross-sectional view of two interconnected structural profiles of FIG. 23 connected to two contiguous erected cabinets.

FIG. 25 shows a transverse cross-sectional view of a structural profile with slot channels in accordance with another alternative embodiment of the present invention.

FIG. 26 shows a transverse cross-sectional view of a structural profile with slot channels in accordance with another alternative embodiment of the present invention.

FIG. 27 shows a transverse cross-sectional view of a structural profile with slot channels in accordance with another alternative embodiment of the present invention, together with two discrete mating mechanical clips.

FIG. 28 shows a transverse cross-sectional view of a structural profile with slot channels in accordance with another alternative embodiment of the present invention.

FIG. 29 shows a transverse cross-sectional view of a structural profile with slot channels in accordance with another alternative embodiment of the present invention.

FIG. 30 shows a transverse cross-sectional view of a structural profile with slot channels in accordance with another alternative embodiment of the present invention.

FIG. 31 shows a transverse cross-sectional view of a structural profile with slot channels in accordance with another alternative embodiment of the present invention.

FIG. 32 shows a transverse cross-sectional view of a structural profile with slot channels in accordance with another alternative embodiment of the present invention.

FIG. 33 shows a perspective view of a structural profile according to another alternative embodiment of the present invention.

FIG. 34 shows a perspective view of the structural profile of FIG. 33, but viewed from an underside thereof.

FIG. 35 shows an exploded, isometric view of parts of a furniture panel connecting system in accordance with an alternative embodiment of the present invention, the furniture panel connecting system including the structural profile of FIG. 33.

### DETAILS OF INVENTION

Various non-limiting examples of the present furniture panel connecting system will now be described in detail. The connecting system components are preferably produced using plastic, but may also be produced from bioplastics or metal. Panels used with the furniture panel connecting system are typically rigid, and made of wood or composite material.

In one embodiment of the furniture panel connecting system, rectangular portions are removed from corners of certain furniture panels. Alternatively, the portions removed can take the form of other shapes, such as a triangular shape, an arcuate shape, arc-shaped, etc.

In this kind of embodiment, the connecting system components span an entire side of a panel where that panel is joined to an adjacent panel. In particular, an elongate structural profile and a pair of end brackets cooperatively span the interface where the two panels meet.

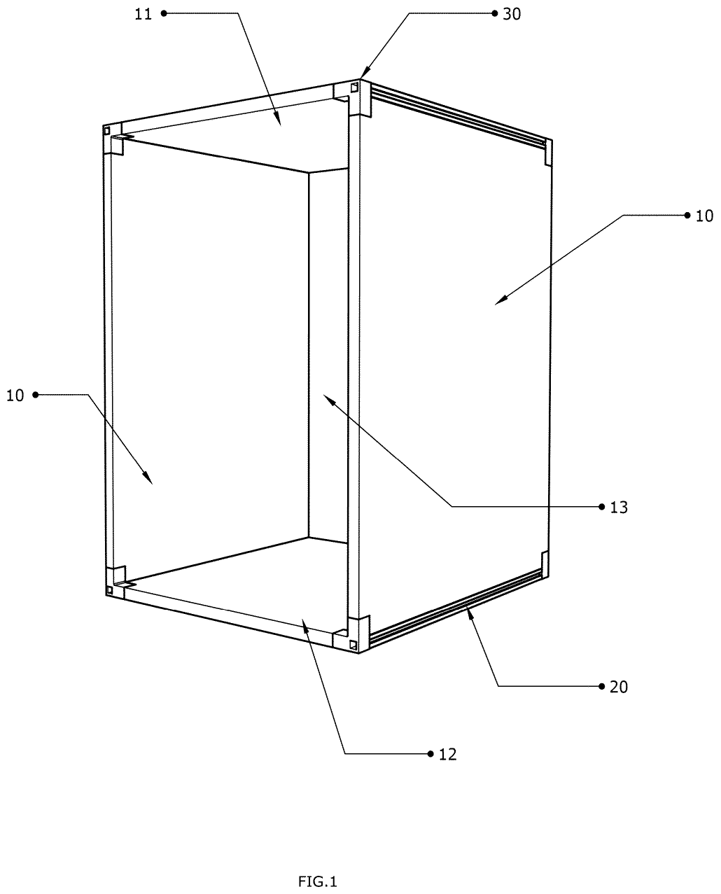

Referring to FIGS. 1-3, there is shown an exemplary cabinet comprising two side panels (10), a top panel (11), a base panel (12), and a back panel (13).

Each of the side, top and base panels (10, 11, 12) is rectangular, and has four rectangular cutouts (15) defined at the four corners thereof respectively. Each panel (10, 11, 12) defines a pair of undercut channels (17) at opposite lateral sides thereof, respectively. The undercut channels (17) run from a front side to a back side of each panel (10, 11, 12), with each undercut channel (17) located between two corresponding cutouts (15). Typically, the panels (10, 11, 12) have been milled to create the undercut channels (17).

Each two adjacent of the side, top and base panels (10, 11, 12) is interconnected by means of an elongate structural profile (20). The structural profile (20) can also be described as a rail connector or simply a connector, and can be made by an extrusion process. End brackets (30) are connected to opposite ends of each structural profile (20) via a pair of fixing elements such as screws (31). The back panel (13) is held in place in the cabinet by the mechanical tension of the connected structural profiles (20). In particular, referring to FIG. 3, recesses (109, 119) are cut into the side and top panels (10, 11). In addition, the back panel (13) has a notch (14) defined in each of top corners thereof, to ensure there is clearance between the back panel (13) and the corresponding structural profile (20).

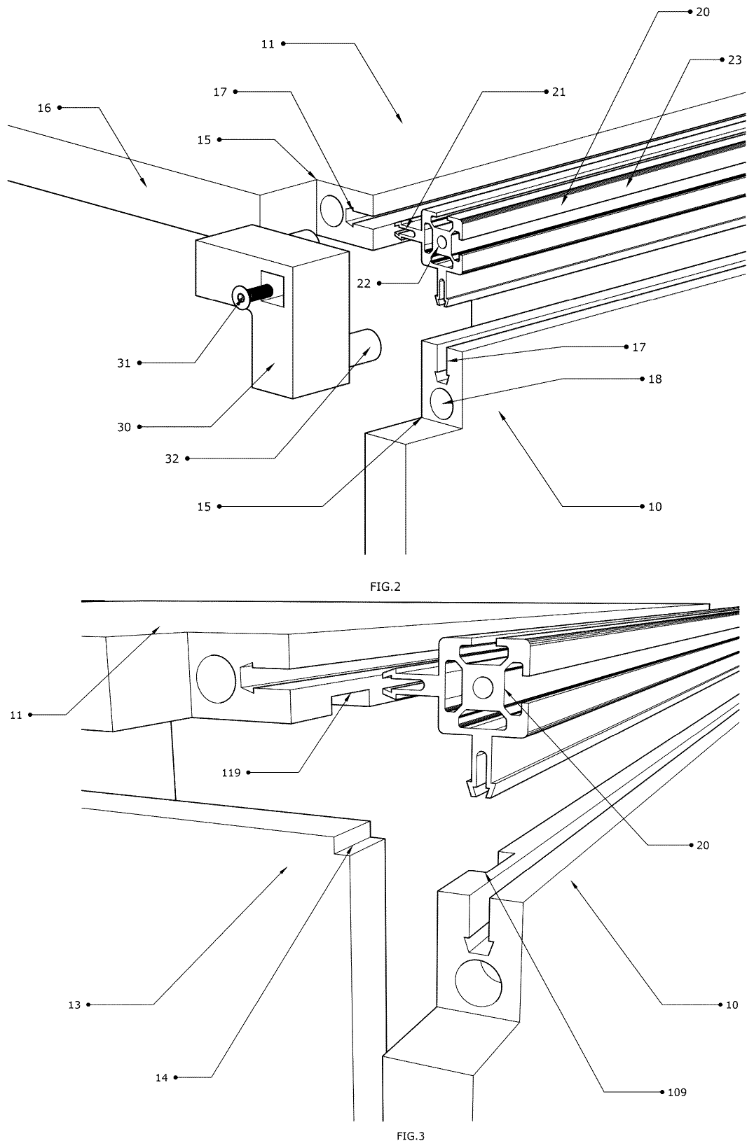

Referring particularly to FIG. 2, there is shown a top right corner of the front of the cabinet, where one of the side panels (10) meets the top panel (11). A rectangular portion of material has been removed from the corner of each panel (10, 11) to define a pair of cutouts (15). The cutouts (15) allow the corresponding end bracket (30) to fit flush with edge faces (16) of the panels (10, 11).

A vertical transverse width of the structural profile (20) is congruent with a thickness of the top panel (11). A horizontal transverse width of the structural profile (20) is congruent with a thickness of the side panel (10). Thus a main body of the structural profile (20) typically has a substantially square transverse cross section.

The structural profile (20) has a pair of elongate tenons in the form of male-type mechanical clips (21), which extend from the main body. The mechanical clips (21) are positioned at right angles to each other. Typically, each mechanical clip (20) is bifurcated, thereby defining a board-shaped (or plate-shaped) stem and two elongate prongs extending outwards from the stem. The prongs are elastically deformable, and are typically symmetrical to each other. A gap between the prongs is substantially uniform. A distal end of each prong has an enlarged barb portion. The two barb portions of the two prongs gradually extend towards each other as they extend in a direction away from the stem. A gap between distalmost ends of the barb portions is substantially the same as the gap between the prongs. A maximum distance spanned by the barb portions in a direction across the gap between the prongs is greater than a thickness of the stem.

The structural profile (20) also has a pair of slot channels (23) at two main sides of the main body, respectively. Each slot channel (23) runs along a length of the main body. Thus the main body defines a pair of symmetrical elongate shoulders at each slot channel (23). Each slot channel (23) is provided for engagement of the structural profile (20) with another structural profile (20, not shown) of an adjacent article of furniture if needed. This is explained in more detail below.

The mechanical clips (21) of the structural profile (20) mate in the corresponding undercut channels (17). This is performed by inserting each mechanical clip (21) into the elongate opening of the undercut channel (17). In this process, the prongs of the mechanical clip (21) resiliently deform towards each other until the barb portions of the prongs reach an innermost enlarged portion of the undercut channel (17). At that point, the prongs elastically rebound to their original state and become fittingly engaged in the undercut channel (17). In this position, shoulders of the barb portions abut shoulders of the undercut channel (17), thereby preventing the mechanical clip (21) from withdrawing from the undercut channel (17). In addition, the stem is typically sized to snugly or frictionally fit in the undercut channel (17) in this position. This helps give the assembly rigidity and resistance to any torsion forces that may be applied.

The end bracket (30) is fixed to the structural profile (20) and the panels (10, 11) at the cutouts (15). In particular, cylindrical plugs (dowels) (32) of the end bracket (30) are interferingly engaged in circular holes (18) which have been pre-drilled in the panels (10, 11). In addition, the screw (31) is passed into a chamber of the end bracket (30) and engaged in a hole (22) of the structural profile (20).

Thus each mechanical clip (21) can be considered to be a connecting means. Each end bracket (30) can be considered to be an alignment means, for preventing or restricting unwanted displacement of the structural profile (20).

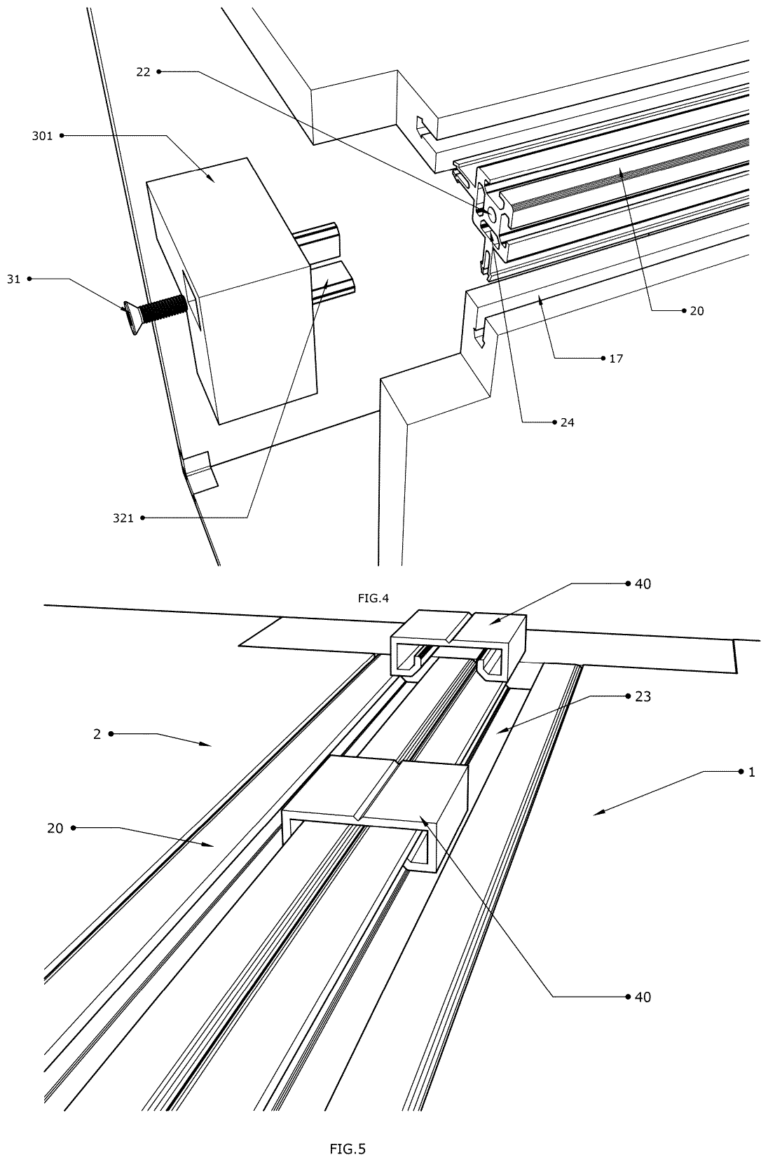

Referring to FIG. 4, there is shown an enlarged, exploded view of the top, right-side front corner of a cabinet, which is formed by plural example furniture panel connecting systems of another embodiment of the present invention. This embodiment is similar to the one shown in FIG. 2, but includes an end bracket (301). The end bracket (301) typically utilizes a pair of plugs (321) which are oriented perpendicular to each other. The plugs (321) are fittingly or interferingly engaged in matching holes (24) which have been pre-formed in an end of the structural profile (20). In the illustrated embodiment, a transverse cross section of each plug (321) is approximately a polygon in the shape of a mushroom head. A transverse cross section of each hole (24) defines a polygon approximately in the shape of a mushroom head. If desired, a screw (31) can be passed into a chamber of the end bracket (301) and engaged in a hole (22) of the structural profile (20).

Referring to FIG. 5, there are shown top rear corners of two contiguous erected cabinets (1, 2). The cabinets (1, 2) can be joined together by one or more interlocking means. In this embodiment, each interlocking means is in the form of a generally U-shaped interlocking clip (40). Distal ends of the interlocking clip (40) are engaged in two corresponding slot channels (23) of two adjacent structural profiles (20).

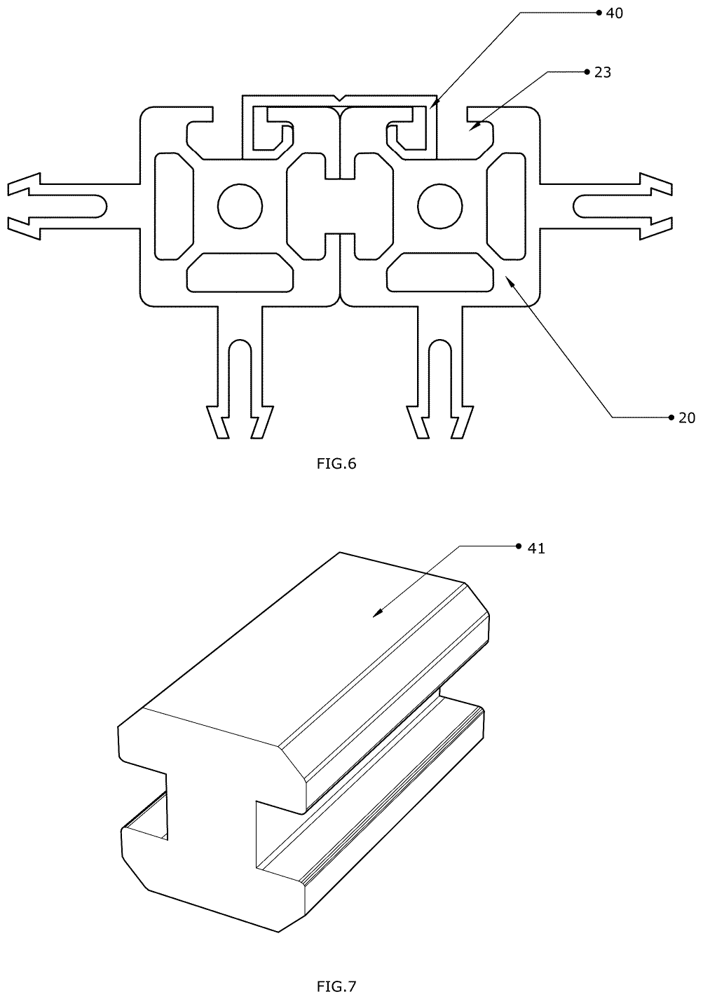

Referring to FIG. 6, there is shown an end view of the interlocking clip (40) joining the two structural profiles (20) together.

Referring to FIG. 7, in an alternative embodiment, each interlocking means can be in the form of a block, such as a generally H-shaped block (41).

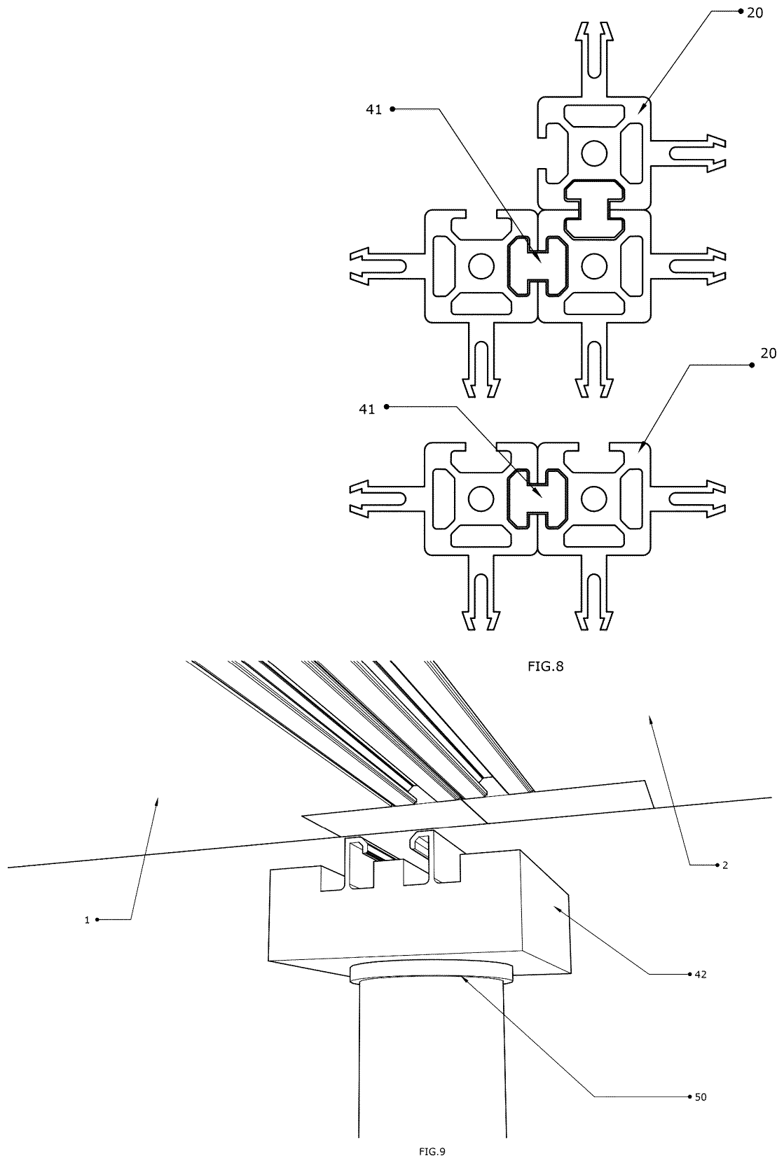

Referring to FIG. 8, one or more blocks (41).can be used to join two structural profiles (20) together, or to join three structural profiles (20) together, or to join even more than three structural profiles (20) together.

Referring to FIG. 9, there are shown bottom rear corners of two contiguous erected cabinets (1, 2). The cabinets (1, 2) can be joined together by one or more interlocking means. In this embodiment, each interlocking means is in the form of an interlocking clipping block (42) capable of receiving an adjustable furniture foot (50).

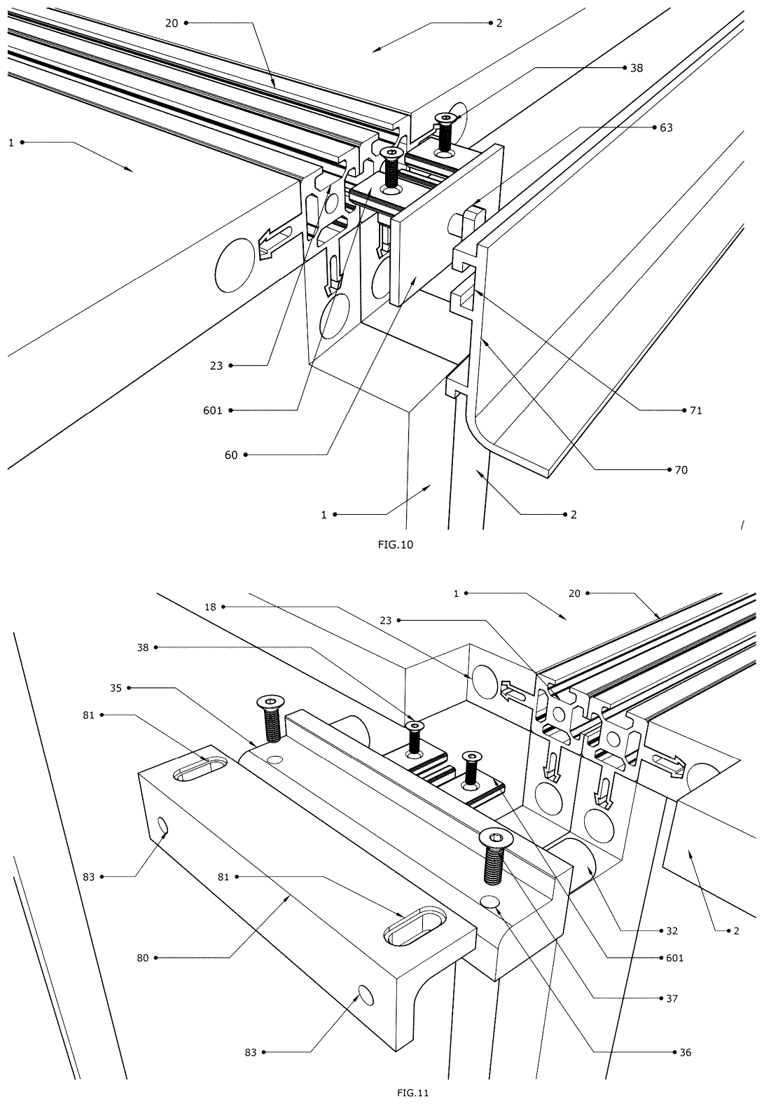

Referring to FIG. 10, there are shown top corners of two contiguous erected cabinets (1, 2). An end bracket (60) has two pairs of plugs (601) extending from an inner main side thereof. The plugs (601) in each pair of plugs (601) are oriented perpendicularly to each other. The plugs (601) are fittingly engaged in corresponding slot channels (23) of two structural profiles (20). Screws (38) can then be employed to fasten two of the plugs (601) in position. The end bracket (60) also has a T-shaped block (63) extending from an outer main side thereof, to retain a handleless profile (70). The handleless profile (70) can also be described as a handleless strip. The T-shaped block (63) of the end bracket (60) is engaged in a handleless profile channel (71) of the handleless profile (70).

To engage the T-shaped block (63) in the handleless profile channel (71), the T-shaped block (63) can simply be slid into the handleless profile channel (71) to an appropriate position, at which the T-shaped block (63) is fittingly engaged in the handleless profile channel (71). Alternatively, the end bracket (60) can first be rotated 90 degrees anticlockwise from its position shown in FIG. 10. Then the T-shaped block (63) is slid into the handleless profile channel (71) to an appropriate position. Next, the end bracket (60) is rotated 90 degrees clockwise so that the T-shaped block (63) is fittingly engaged in the handleless profile channel (71).

In other embodiments, the T-shaped block (63) can instead have another suitable shape for appropriate engagement in the handleless profile channel (71). In another embodiment, the handleless profile (70) can further or alternatively be a decorative profile.

Referring to FIG. 11, there are shown top corners of two contiguous erected cabinets (1, 2). An end bracket (35) functions as both an alignment means and an interlocking means for two structural profiles (20). The end bracket (35) has two pairs of plugs (601) extending from a centre portion of an inner main side thereof, and a pair of cylindrical plugs (32) extending from end portions of the inner main side thereof. The plugs (601) are fittingly engaged in corresponding slot channels (23) of the structural profiles (20). The cylindrical plugs (32) are interferingly engaging in holes (18) of panels (not labelled) of the cabinets (1, 2). Screws (38) can then be employed to fasten two of the plugs (601) in position. The end bracket (35) also connects with a wall plate (80). The wall plate (80) has adjustment slots (81), and is clamped to the end bracket (35) by screws (37) that engage in threaded holes of the end bracket (35). The wall plate (80) has a pair of mounting holes (83), which allow the wall plate (80) to be fixed to a pre-drilled wall, typically using screws with wall plugs.

As described above and shown in the drawings, the structural profile (20) includes the holes (24) at positions adjacent to the corresponding mechanical clips (21), and the slot channels (23) at sides of the main body that do not have the mechanical clips (21). Even when the slot channels (23) are not immediately used, such as in the case of constructing a single cabinet, the slot channels (23) render the cabinet ready for future expansion or upgrading with more panels should the need arise.

In another embodiment of the furniture panel connecting system, discrete rectangular portions are removed from joining edges of certain furniture panels. For each such panel, the recesses thus formed are sized to be congruent to the thickness of a perpendicularly adjoining panel.

In this kind of embodiment, plural structural profiles are used to create, for example, a cabinet that is expected to sustain only lower load bearing conditions. In addition, the connecting system may utilize cylindrical plugs that are substantially coplanar with and engaged in both adjoining panels.

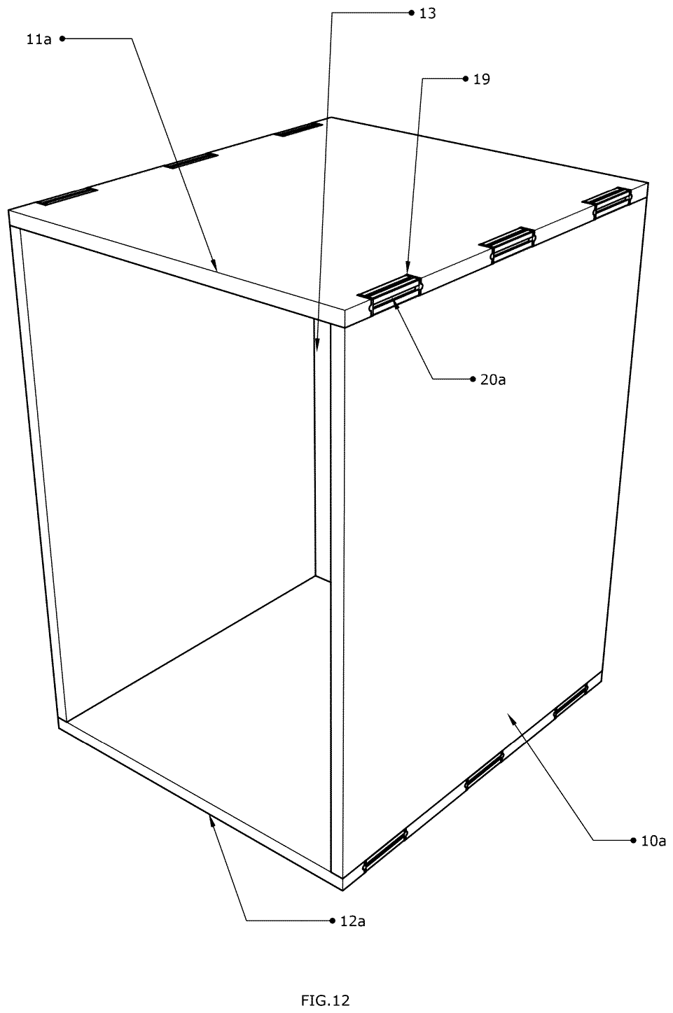

Referring to FIG. 12, there is shown an exemplary cabinet comprising two side panels (10a), a top panel (11a), a base panel (12a) and a back panel (13). Each of the top and base panels (11a, 12a) is rectangular, and defines six recesses (19). For each of the top and base panels (11a, 12a), three of the recesses (19) are at one lateral side thereof, and the other three recesses (19) are at an opposite lateral side thereof. Each of the top and base panels (11a, 12a) has six structural profiles (20a) at the recesses (19) thereof, respectively. The three structural profiles (20a) at each lateral side are aligned from a front side to a back side of each of the top and base panels (11a, 12a),

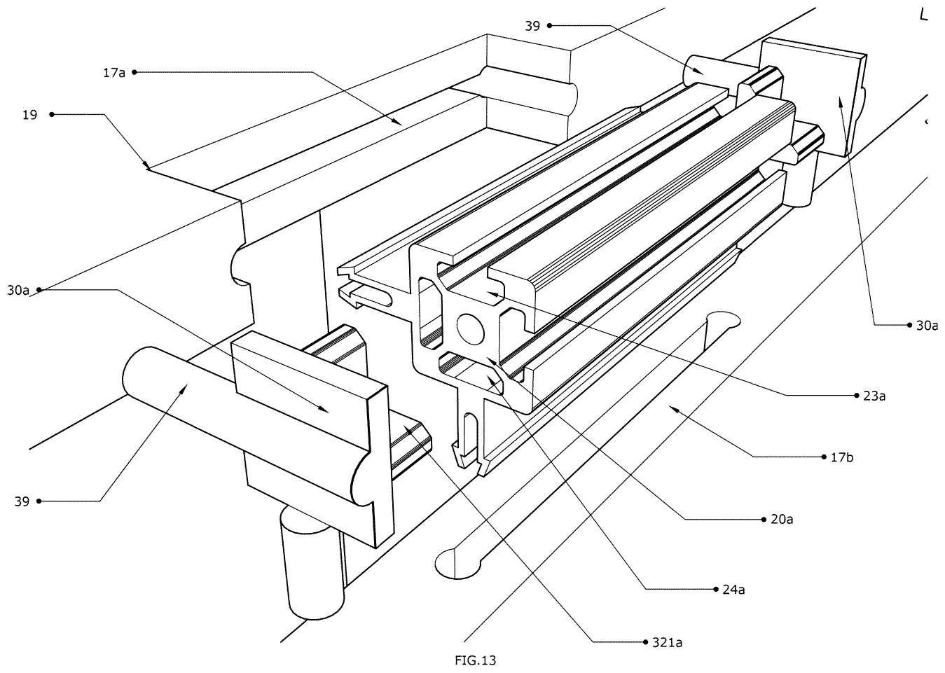

Referring also to FIG. 13, a horizontal transverse width of each recess (19) of the top panel (11a) is the same as a thickness of the side panel (10a). This allows the structural profiles (20a) to sit directly over and in alignment with the side panel (10a) when the structural profiles (20a) interconnect the top panel (11a) and the side panel (10a).

Two end brackets (30a) are respectively engaged in opposite ends of each structural profile (20a). Each end bracket (30a) has a pair of plugs (321a) which are oriented perpendicular to each other, and a pair of cylindrical locating pins (39) which are oriented perpendicular to each other.

The plugs (321a) are fittingly or interferingly engaged in matching holes (24a) which have been pre-formed in an end of the structural profile (20a). In the illustrated embodiment, a transverse cross section of each plug (321a) is approximately a polygon in the shape of a mushroom head, and a transverse cross section of each hole (24a) defines a polygon approximately in the shape of a mushroom head.

In the top panel (11a), each recess (19) has a pair of enlarged, semi-cylindrical shoulder portions at opposite ends thereof, respectively. Correspondingly, an undercut channel (17a) has a pair of cylindrical shoulder portions at opposite ends thereof, respectively. Each semi-cylindrical shoulder portion communicates with the corresponding adjacent cylindrical shoulder portion. The combined semi-cylindrical and cylindrical shoulder portions are sized to fittingly receive a corresponding locating pin (39) of a corresponding end bracket (30a) therein. The shoulder portions of the recess (19) and the undercut channel (17a) can be formed by routing.

Thus the end brackets (30a) are securely engaged in the recesses (19) of the top panel (11a).

In the side panel (10a), an undercut channel (17b) has a pair of enlarged cylindrical shoulder portions at opposite ends thereof, respectively. The cylindrical shoulder portions are sized to fittingly receive corresponding locating pins (39) of the corresponding end brackets (30a) therein. The shoulder portions of the undercut channel (17b) can be formed by routing.

Thus the end brackets (30a) are securely engaged with the side panel (10a).

Each structural profile (20a) also has a pair of slot channels (23a).

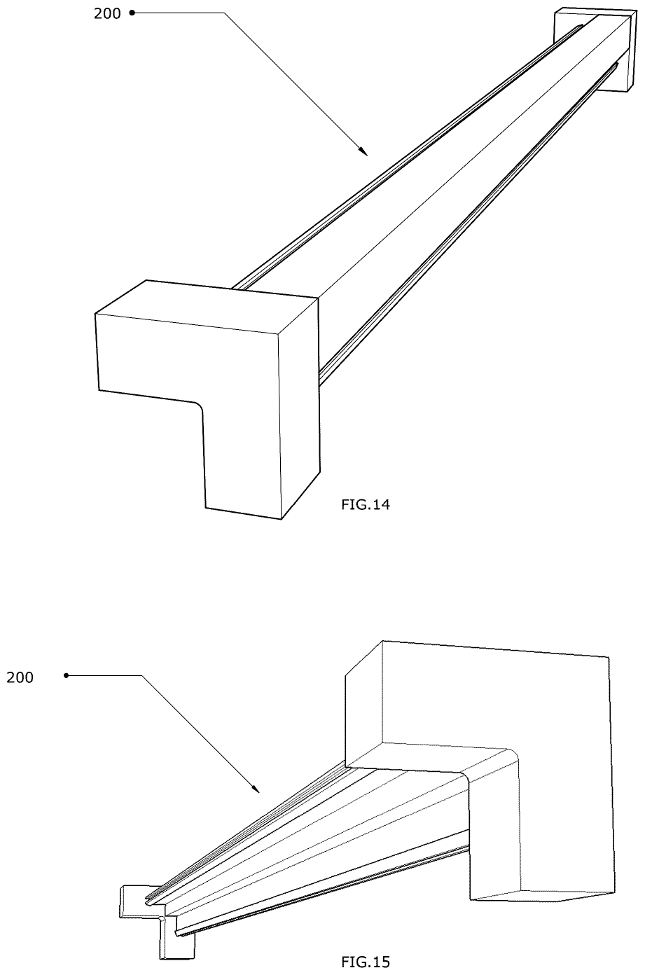

Referring to FIGS. 14-15, there is shown an elongate furniture panel connector (200) according to an alternative embodiment of the present invention. The connector (200) is similar in principle to the above-described elongate structural profile (20) and pair of end brackets (30). However, a structural profile portion and two end bracket portions of the connector (200) are all formed together as a single, unitary piece of material. In addition, the structural profile portion does not have any slot channels, and the end bracket portions do not have any chambers or cylindrical plugs. Referring to FIG. 16, there is shown a transverse cross-sectional view of the structural profile portion. In other respects, the structure and function of the connector (200) are similar to those of the above-described structural profile (20) and end brackets (30).

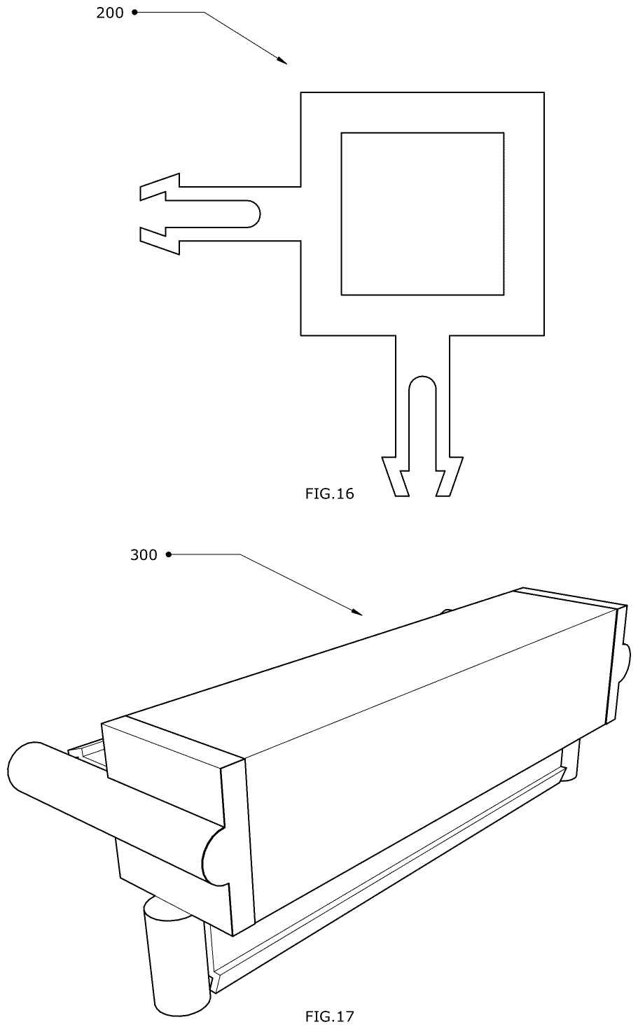

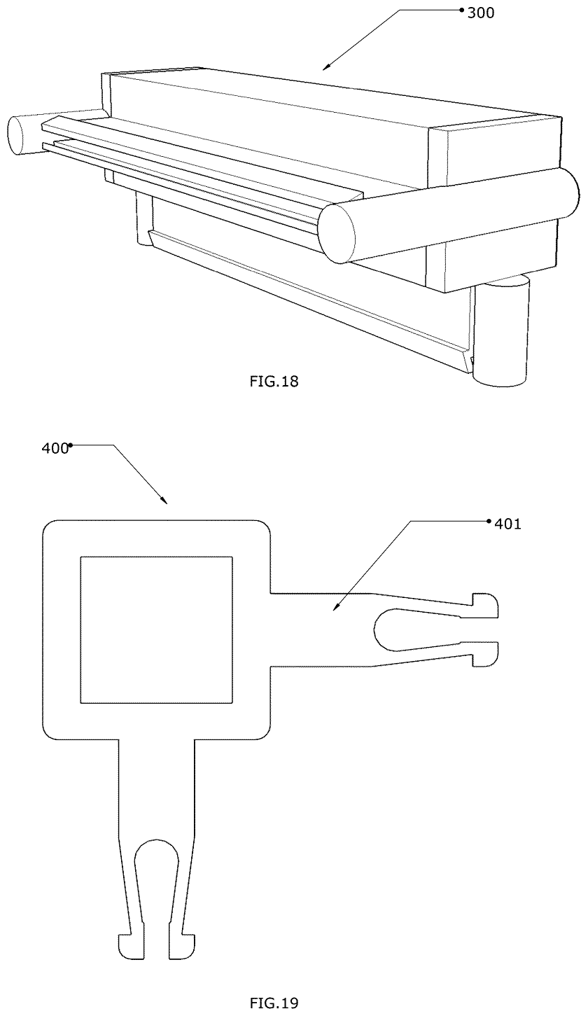

Referring to FIGS. 17-18, there is shown a furniture panel connector (300) according to an alternative embodiment of the present invention. The connector (300) is similar in principle to the above-described structural profile (20a) and pair of end brackets (30a). However, a structural profile portion and two end bracket portions of the connector (300) are all formed together as a single, unitary piece of material. In addition, the structural profile portion does not have any slot channels (23a), and the end bracket portions do not have any plugs (321a). In other respects, the structure and function of the connector (300) are similar to those of the above-described structural profile (20a) and end brackets (30a).

Referring to FIG. 19, there is shown a transverse cross-sectional view of a structural profile portion of a furniture panel connector (400) in accordance with another alternative embodiment of the present invention. The structural profile portion of the connector (400) is similar to the above-described structural profile portion of the connector (200) seen in FIG. 16. However, elongate prongs of each of mechanical clips (401) of the connector (400) gradually extend towards each other as they extend in a direction away from a stem of the mechanical clip (401). Thus a gap between the prongs gradually decreases in the direction away from the stem. The prongs are elastically deformable, and are preferably symmetrical to each other. A distal end of each prong has an enlarged barb portion. The two barb portions extend in mutually opposite directions away from each other from the distal ends of the prongs, respectively. A maximum distance spanned by the barb portions in a direction across a gap between the prongs is the same as or less than a thickness of the stem. Each mechanical clip (401) is configured to be fittingly, interferingly and/or snappingly engaged in a matching undercut channel of a panel (see FIG. 20).

Referring to FIG. 20, there is shown a cross-sectional view of the furniture panel connector (400) interconnecting a side panel (10) and a top panel (11).

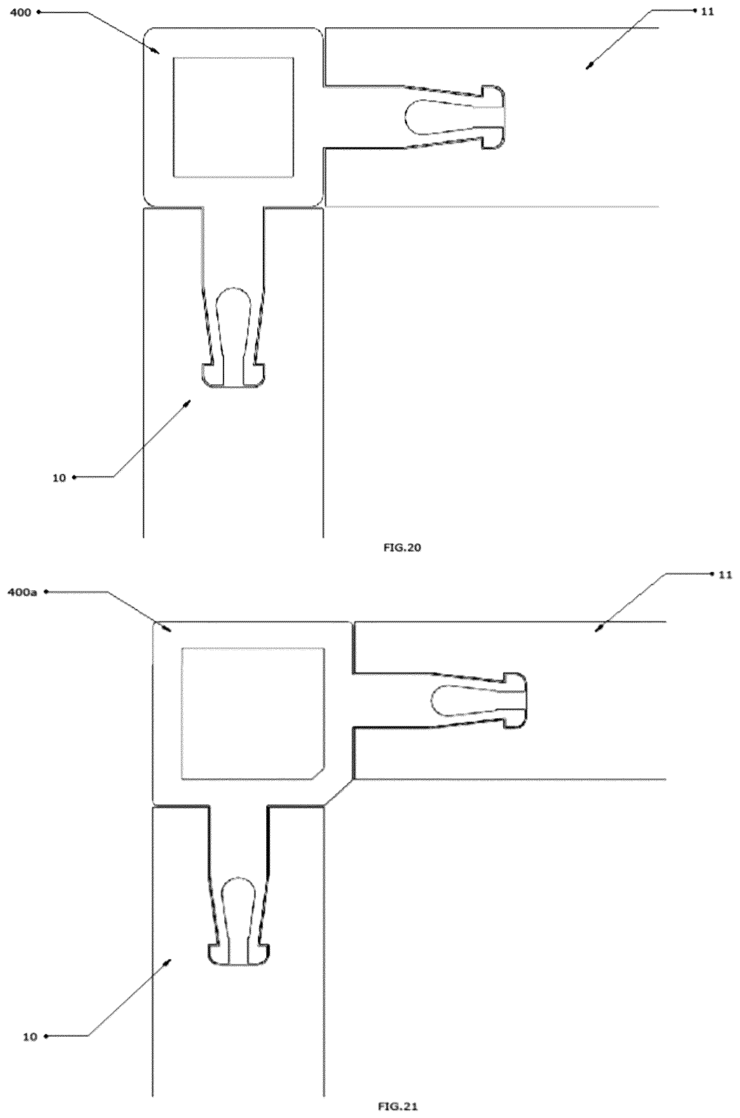

Referring to FIG. 21, there is shown a cross-sectional view of a side panel (10) and a top panel (11) joined together by an elongate furniture panel connector (400a) in accordance with an alternative embodiment of the present invention. An overall vertical width of a structural profile portion of the connector (400a) is greater than a thickness of the top panel (11). An overall horizontal width of the structural profile portion of the connector (400a) is greater than a thickness of the side panel (10). Planar faces of the structural profile portion of the connector (400a) adjacent to the mating panels (10, 11) have a width congruent with a thickness of each of the panels (10, 11). A transverse cross section of the structural profile portion of the connector (400a) is a polygon, which includes an oblique straight side spanning between the side and top panels (10, 11). Put another way, the structural profile portion of the connector (400a) has a planar chamfer between the side and top panels (10, 11). The chamfered configuration helps prevent accumulation of dirt and dust in the corner where the side and top panels (10, 11) meet. In other embodiments herein, a structural profile can have the same cross section as that shown in FIG. 21.

Referring to FIG. 22, there is shown a cross-sectional view of a side panel (10) and a top panel (11) joined together by an elongate furniture panel connector (400b) in accordance with another alternative embodiment of the present invention. An overall vertical width of a structural profile portion of the connector (400b) is greater than a thickness of the top panel (11). An overall horizontal width of the structural profile portion of the connector (400b) is greater than a thickness of the side panel (10). Planar faces of the structural profile portion of the connector (400b) adjacent to the mating panels (10, 11) have a width congruent with a thickness of each of the panels (10, 11). A transverse cross section of the structural profile portion of the connector (400b) is a polygon. The polygon includes a curved, concave side spanning between the side and top panels (10, 11). Put another way, the structural profile portion of the connector (400b) has a curved, concave chamfer between the side and top panels (10, 11). The chamfered configuration helps prevent accumulation of dirt and dust in the corner where the side and top panels (10, 11) meet. In other embodiments herein, a structural profile can have the same cross section as that shown in FIG. 22.

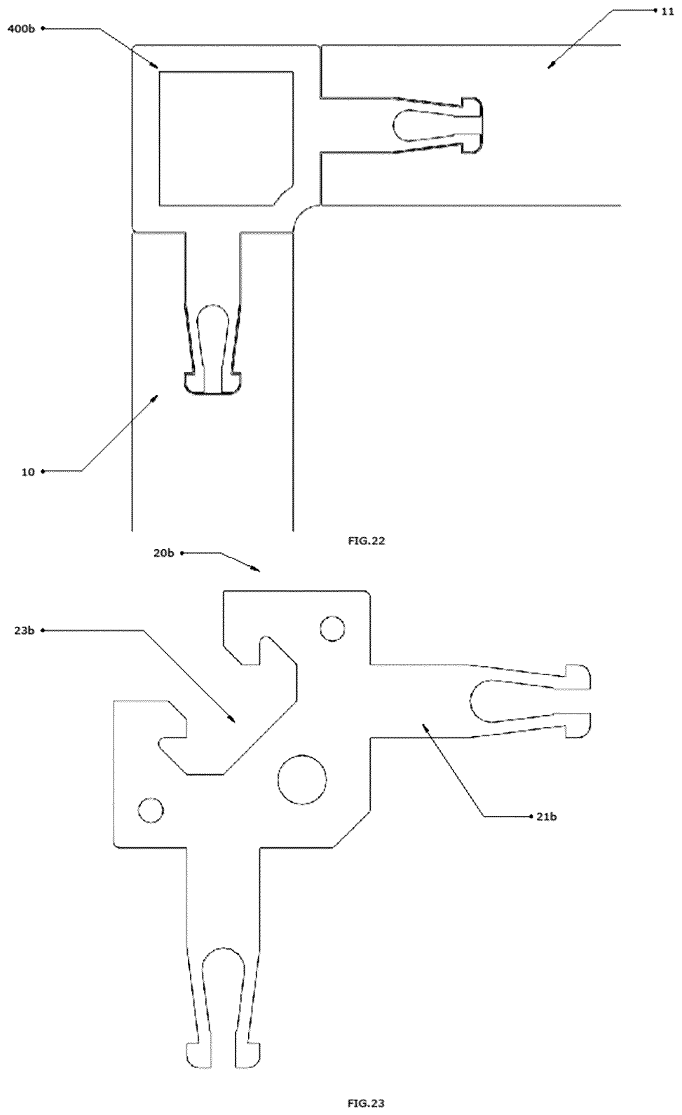

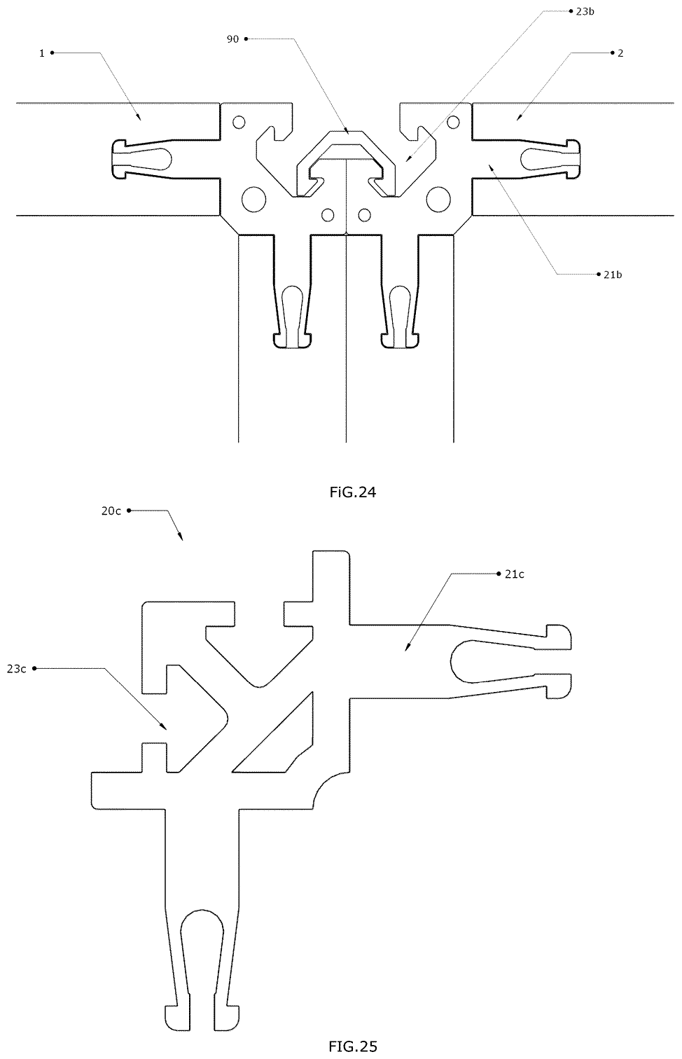

Referring to FIG. 23, there is shown a transverse cross-sectional view of a structural profile (20b) in accordance with an alternative embodiment of the present invention. The structural profile (20b) is similar to the structural profile portion of the above-described connector (400a). However, a corner portion of the structural profile (20b) distal from both of mechanical clips (21b) is truncated. In addition, a slot channel (23b) is defined in a main body of the structural profile (20b) at the truncated corner portion. A shape defined by the slot channel (23b) is approximately that of a mushroom. The slot channel (23b) is configured for receiving a mating interlocking means (see FIG. 24), so that the structural profile (20b) can be interconnected with one or more other adjacent structural profiles (20b, not shown). Further, elongate prongs of each mechanical clip (21b) are in the form of the prongs of the connector (400).

Referring to FIG. 24, there is shown a cross-sectional view of two structural profiles (20b) connected to two contiguous erected cabinets (1, 2), respectively. The structural profiles (20b) are interconnected by interlocking means in the form of an elongate, generally U-shaped interlocking clip (90). The interlocking clip (90) is similar in principle to the above-described interlocking clip (40), and is fittingly engaged in the slot channels (23b) of the structural profiles (20b). As seen in the illustration, tops of main bodies of the structural profiles (20b) are substantially flush with tops of panels (not labelled) of the cabinets (1, 2). A top of the interlocking clip (90) is recessed relative to the tops of the panels. In an alternative embodiment, an interlocking clip (not shown) can be configured such that when it is engaged in the slot channels (23b), a top of the interlocking clip is substantially flush with the tops of the panels.

Referring to FIG. 25, there is shown a transverse cross-sectional view of a structural profile (20c) in accordance with another alternative embodiment of the present invention. The structural profile (20c) is similar to the above-described structural profile portion of the connector (400b) seen in FIG. 22. However, each of two adjacent sides of a main body of the structural profile (20c) opposite to two adjacent sides having mechanical clips (21c) are step shaped. An outermost step of each step shape corresponds to the respective adjacent side of the main body having the mechanical clip (21c). An innermost (recessed) step of each step shape adjoins the innermost (recessed) step of the other step shape. A slot channel (23c) is defined in each innermost step. A shape of the slot channel (23c) is approximately that of an arrowhead. Each slot channel (23c) is configured for receiving a mating interlocking means (not shown), so that the structural profile (20c) can be interconnected with one or more other structural profiles (20c, not shown).

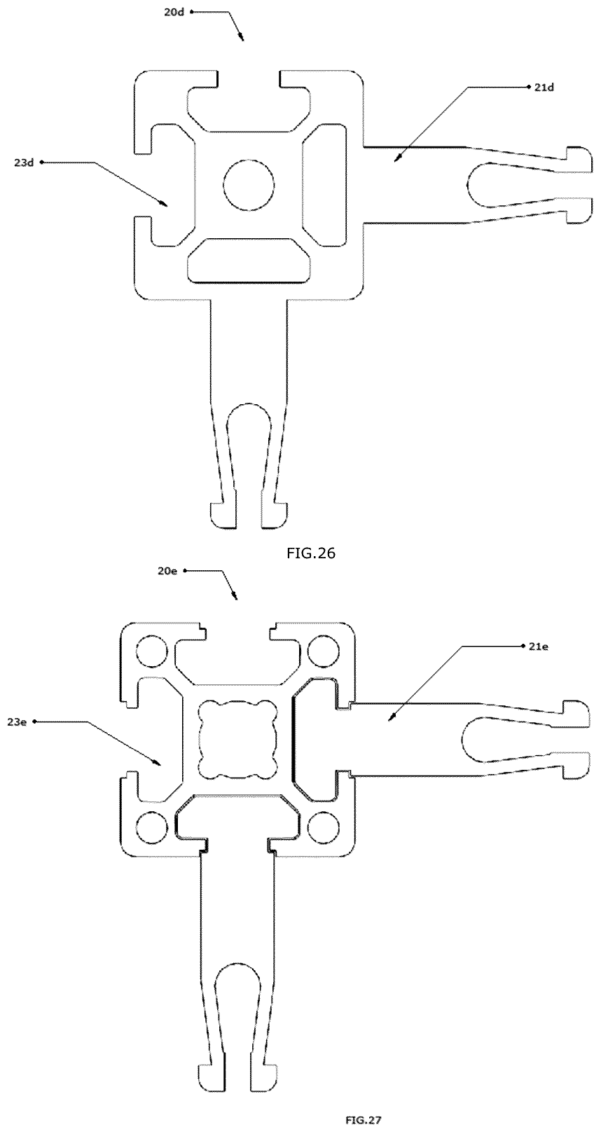

Referring to FIG. 26, there is shown a transverse cross-sectional view of a structural profile (20d) in accordance with another alternative embodiment of the present invention. The structural profile (20d) is similar to the above-described structural profile (20) seen in FIG. 6. However, prongs of mechanical clips (21d) of the structural profile (20d) are instead in the form of the prongs of the connector (400).

Referring to FIG. 27, there is shown a transverse cross-sectional view of a structural profile (20c) in accordance with another alternative embodiment of the present invention. The structural profile (20e) is similar to the above-described structural profile (20d) seen in FIG. 26. However, the structural profile (20c) does not have any mechanical clips extending from a main body thereof. Instead, each of four sides of the main body of the structural profile (20e) has a slot channel (23e) defined therein. A discrete mating mechanical clip (21e) can be engaged in any selected one of the slot channels (23c).

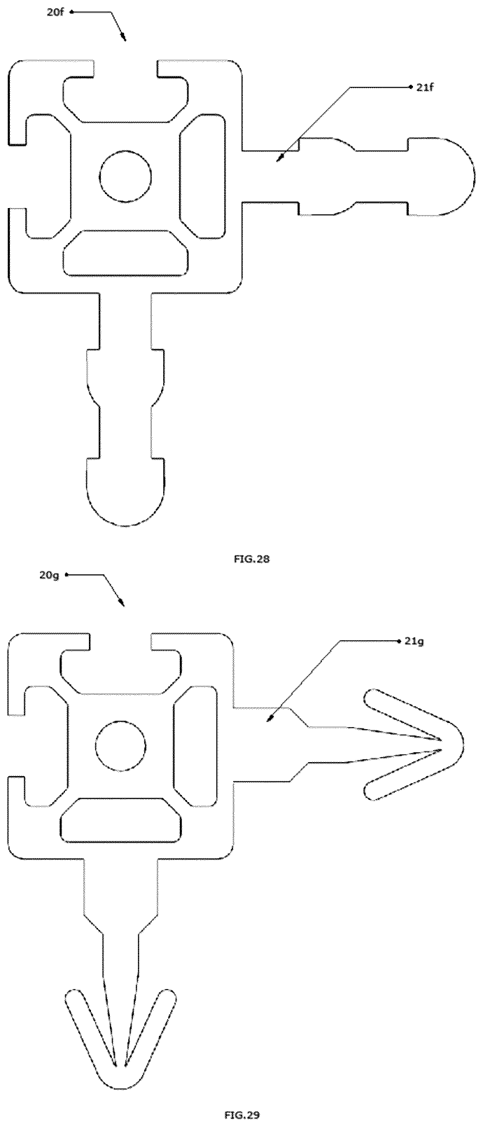

Referring to FIG. 28, there is shown a transverse cross-sectional view of a structural profile (20f) in accordance with another alternative embodiment of the present invention. The structural profile (20f) is similar to the above-described structural profile (20) seen in FIG. 6. However, instead of mechanical clips, each of tenons of the structural profile (20f) is in the form of a board (21f). Each board (21f) has a pair of ribs formed on opposite main surfaces thereof, and an enlarged distal end. The pair of ribs is located between the main body and the distal end. A distalmost portion of the enlarged distal end is rounded and convex. A distal end of each rib has a smooth convex surface adjoining the surface of the board (21f). Each board (21f) is configured for inserting into a mating undercut channel of a panel (not shown) made of flexible material. During insertion, the enlarged distal end and the ribs cause walls of the undercut channel to resiliently expand. When the board (21f) is fully inserted into the undercut channel, the walls elastically rebound such that either or both of shoulders of the ribs and shoulders of the enlarged distal end are retained by the walls.

Referring to FIG. 29, there is shown a transverse cross-sectional view of a structural profile (20g) in accordance with another alternative embodiment of the present invention. The structural profile (20g) is similar to the above-described structural profile (20) seen in FIG. 6. However, each of mechanical clips (21g) of the structural profile (20g) is in the form of a tapered, board-shaped stem having two elastically deformable wings at a distal end thereof. The wings are preferably symmetrical to each other, and extend from the distal end obliquely towards a main body of the structural profile (20g), with the wings gradually diverging from each other. Each mechanical clip (21g) is configured for inserting into a mating undercut channel of a panel (not shown). During insertion, the wings resiliently deform inward. When the mechanical clip (21g) is fully inserted into the undercut channel, the wings elastically rebound such that distal ends of the wings are retained by shoulders of the walls of the undercut channel.

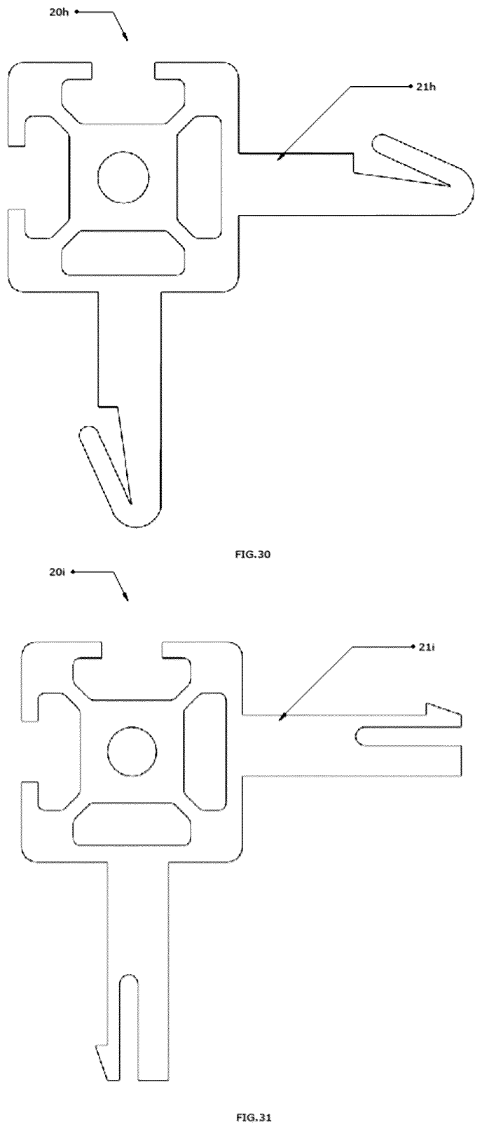

Referring to FIG. 30, there is shown a transverse cross-sectional view of a structural profile (20h) in accordance with another alternative embodiment of the present invention. The structural profile (20h) is similar to the above-described structural profile (20) seen in FIG. 6. However, each of mechanical clips (21h) of the structural profile (20h) is asymmetrical. In particular, the mechanical clip (21h) has a stem portion, and a clip portion extending from the stem portion. The clip portion includes a narrowed, tapered base section extending from the stem portion, and an arm section extending obliquely from a distal end of the base section in a direction generally towards a main body of the structural profile (20h). The arm section has a substantially uniform thickness, and is elastically deformable relative to the base section. The mechanical clip (21h) is configured for inserting into a mating undercut channel of a panel (not shown). During insertion, the arm section resiliently deforms inward. When the mechanical clip (21h) is fully inserted into the undercut channel, the arm section elastically rebounds such that a distal end of the arm section is retained by a shoulder of a wall of the undercut channel. An advantage of the mechanical clips (21h) is that they are able to engage in relatively thin panels. This makes the structural profile (20h) suitable for joining slender panels.

Referring to FIG. 31, there is shown a transverse cross-sectional view of a structural profile (20i) in accordance with another alternative embodiment of the present invention. The structural profile (20i) is similar to the above-described structural profile (20) seen in FIG. 6. However, each of mechanical clips (21i) of the structural profile (20i) is asymmetrical. In particular, the mechanical clip (21i) has only a single elongate prong extending outwards from the stem. Instead of a second elongate prong, there is a board portion having a substantially uniform thickness extending outwards from the stem portion. The mechanical clip (21i) is configured for inserting into a mating undercut channel of a panel (not shown). An advantage of the mechanical clips (21i) is that they are able to engage in relatively thin panels. This makes the structural profile (20i) suitable for joining slender panels.

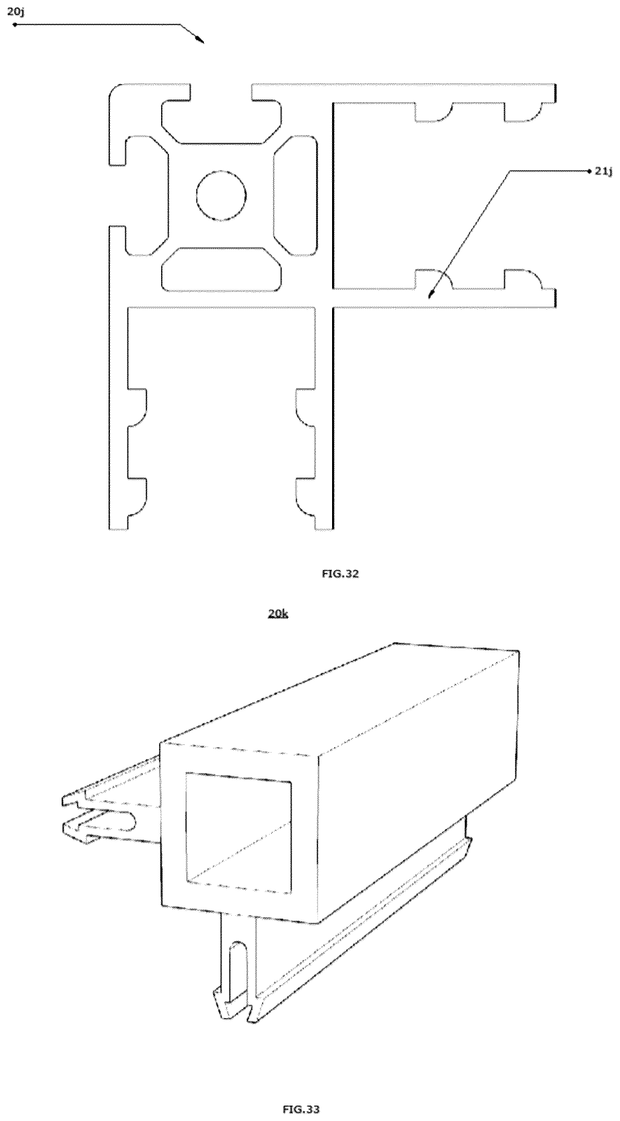

Referring to FIG. 32, there is shown a transverse cross-sectional view of a structural profile (20j) in accordance with another alternative embodiment of the present invention. The structural profile (20j) is similar to the above-described structural profile (20) seen in FIG. 6. However, each of tenons of the structural profile (20j) is in the form of a pair of elongate prongs (21j). Each pair of elongate prongs (21j) in cooperation with a main body of the structural profile (20j) constitutes a female-type mechanical clip. The two prongs (21j) are mutually symmetrical, and are elastically deformable. An outer surface of one of the prongs (21j) is coplanar with a corresponding outer surface of the main body of the structural profile (20j). An outer surface of the other prong (21j) is coplanar with a corresponding outer surface of the main body of the structural profile (20j). Each prong (21j) has a substantially uniform thickness, and a pair of ribs formed on an inner surface thereof. Each mechanical clip is configured for mating with a corresponding edge portion of a panel (not shown). During mating, the prongs (21j) resiliently deform outwardly. When the mechanical clip is fully positioned over the edge portion, the prongs (21j) elastically rebound such that shoulders of the ribs are retained by shoulders of the edge portion.

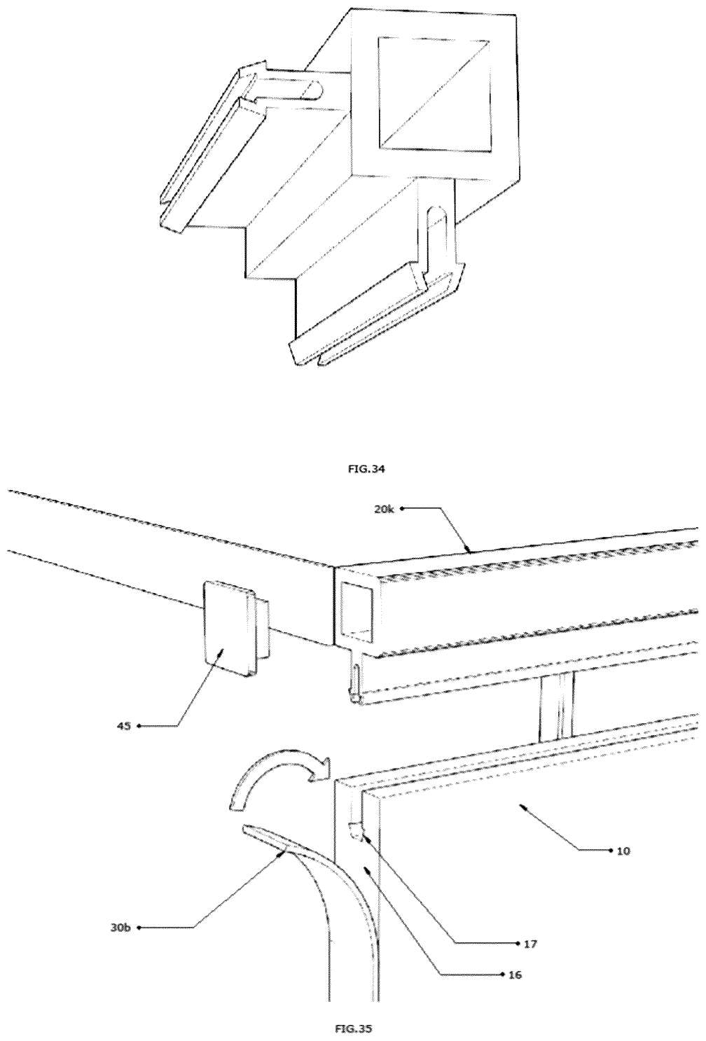

Referring to FIGS. 33-34, there is shown a structural profile (20k) according to another alternative embodiment of the present invention. The structural profile (20k) is the same as the above-described structural profile portion of the connector (200). The structural profile (20k) can be used without any end brackets if desired.

Referring to FIG. 35, this shows an exploded, isometric view of parts of a furniture panel connecting system in accordance with an alternative embodiment of the present invention. The furniture panel connecting system includes the structural profile (20k), a pair of alignment means in the form of strips of material (30b), and a pair of plugs (45). The structural profile (20k) is engaged in an undercut channel (17) of a side panel (10). Each strip of material (30b) can be made of polyurethane (PU) for example, and has a transverse width congruent with a thickness of the panel (10). Each strip of material (30b) is attached to a corresponding edge face (16) of the panel (10). The strip of material (30b) can be adhered to the edge face (16) by glue for example, and covers a corresponding end of the undercut channel (17). Each plug (45) has an enlarged head portion, and an engaging portion extending from the head portion. A thickness of the head portion is congruent with a thickness of each strip of material (30b). A horizontal width of the head portion is congruent with a transverse horizontal width of the structural profile (20k), and a vertical width of the head portion is congruent with a transverse vertical width of the structural profile (20k). The engaging portion is interferingly engaged in a corresponding end of the structural profile (20k). Thus the head portion is substantially flush with the adjacent strip of material (30b). An advantage of the furniture panel connecting system is that the panel (10) does not require any cutouts.

In general, it is envisaged that different sizes and configurations of structural profiles can be produced to suit different sizes of furniture and other applications.

The invention may take other forms different to that specifically described above. For example, the structural profiles can be made of metal to take higher loads. Different colours can be used to simplify the construction of more complex furniture.

The above-described structures and principles can also be used to erect freestanding partitions, which can for example be used for temporary exhibitions, etc. Further, the above-described structures and principles can be used to form structures such as cubicles.

Various features of the above-described embodiments can be utilized or combined in any way to achieve suitable structures not explicitly described or shown herein. Further modifications of the above-described embodiments will be apparent to those skilled in the art without departing from the spirit or scope of the present invention.

1. A panel connecting system for interconnecting at least two panels, the connecting system comprising:
a structural profile comprising:
an elongate main body having a generally square transverse cross section; and
one or more elongate tenons extending from one or more sides of the main body, each of the tenons configured for fittingly engaging in one or more mating undercut channels of one of the panels; and
a pair of alignment means, the two alignment means configured to engage with opposite ends of the main body, respectively, and restrict unwanted displacement of the structural profile when the structural profile is engaged with the panels.

2. A panel connecting system according to claim 1, in which the structural profile further comprises one or more slot channels defined in one or more sides of the main body, respectively, and running along a length of the main body, each of the slot channels thereby defining a pair of symmetrical shoulders of the main body.

3. A panel connecting system according to claim 1 or 2 claim 1, in which the one or more tenons comprises two tenons, each of two sides of the main body with the two tenons defines a planar face, a transverse width of each planar face is configured to be congruent with a thickness of a corresponding one of the panels, an overall first transverse width of the main body is configured to be greater than a thickness of a corresponding first one of the panels, an overall second transverse width of the main body perpendicular to the first transverse width is configured to be greater than a thickness of a corresponding second one of the panels, and the main body comprises a chamfer face along a length thereof between the two planar faces.

4. A panel connecting system according to claim 3, in which the structural profile further comprises a slot channel defined in a corner portion of the main body diagonally opposite from the chamfer face and running along a length of the main body, thereby defining a pair of symmetrical shoulders of the main body.

5. A panel connecting system according to claim 1, 2 or 3 claim 2, in which each tenon comprises a pair of mutually symmetrical, elastically deformable elongate prongs, each prong comprises a barb at a distal end thereof, the barbs extend away from each other in mutually opposite directions, and the prongs are elastically deformable towards each other into a gap between the prongs

6. A panel connecting system according to claim 5, in which each tenon further comprises a stem interconnecting the pair of prongs and the main body, and a maximum distance spanned by the barbs in a direction across the gap is greater than a thickness of the stem.

7. A panel connecting system according to claim 5, in which each tenon further comprises a stem interconnecting the pair of prongs and the main body, and a maximum distance spanned by the barbs in a direction across the gap is the same as or less than a thickness of the stem.

8. A panel connecting system according to claim 1, in which each tenon comprises a stem extending from the main body, and an elastically deformable prong extending from a distal end of the stem, the prong comprises an outwardly protruding barb at a distal end thereof, and a thickness of the prong is less than a thickness of the stem.

9. (canceled)

10. A panel connecting system according to claim 1, 2 or 3 claim 2, in which each tenon is in the form of a tapered, board-shaped stem having two elastically deformable wings at a distal end thereof, and the wings extend from the distal end obliquely towards the main body of the structural profile, with the wings gradually diverging from each other.

11. A panel connecting system according to claim 1, 2 or 3 claim 2, in which each tenon comprises a stem extending from the main body, and a clip extending from a distal end of the stem; the clip comprises a base section extending from the distal end of the stem, and an arm section extending obliquely from a distal end of the base section in a direction generally towards the main body; a thickness of the base section is less than a thickness of the stem; and the arm section is elastically deformable relative to the base section.

12. (canceled)

13. A panel connecting system according to claim 1, 2 or 3 claim 2, in which each tenon comprises a pair of mutually symmetrical, elastically deformable prongs, each of the prongs comprises a rib on an inner side thereof. the two ribs extend towards each other, and the prongs are elastically deformable away from each other.

14. (canceled)

15. A panel connecting system according to claim 2 or 3 claim 2, further comprising another structural profile and an interlocking means, wherein the interlocking means is configured for engaging in one of the slot channels of each of the structural profiles thereby interlocking the structural profiles, and is further configured for engaging with a furniture foot.

16. (canceled)

17. (canceled)

18. A panel connecting system according to claim 1, 2 or 3 claim 2, in which each alignment means comprises a plug, and the plug is configured to be engaged in the main body such that the alignment means is attached to the main body.

19. A panel connecting system according to claim 1, 2 or 3 claim 2, in which each alignment means is generally L-shaped, the alignment means has a planar L-shaped face, a corner portion of the L-shaped face is sized to abut an end of the main body of the structural profile, the alignment means comprises a pair of plugs located at opposite ends of the L-shaped face, and the plugs are configured for engaging in the panels.

20. (canceled)

21. A panel connecting system according to claim 1, 2 or 3 claim 2, in which each alignment means is generally L-shaped, the alignment means has a planar L-shaped face, a corner portion of the L-shaped face is sized to abut an end of the main body of the structural profile, the alignment means comprises a plug located at the corner portion, and the plug is configured for engaging in the end of the main body of the structural profile.

22. A panel connecting system according to claim 1, 2 or 3 claim 2, in which each alignment means comprises a main body, a plug extending from a main face of the main body, and a pair of locating pins extending from two sides of the main body; the main body of the alignment means is sized and shaped to be congruent with a size and the shape of the transverse cross section of the main body of the structural profile, the plug is configured to be engaged in a matching hole of the end of the structural profile, the pins extend from the main body of the alignment means in a first direction and a second direction respectively, the first and second directions are perpendicular to each other, and each of the pins is configured to be engaged in a matching void of a corresponding one of the panels.

23. A panel connector for interconnecting at least two panels, the panel connector comprising:
a structural profile portion comprising:
an elongate main body having a generally square transverse cross section; and
a plurality of elongate tenons extending from a plurality of sides of the main body, each of the tenons configured for fittingly engaging in one or more mating undercut channels of one of the panels; and
a pair of alignment portions adjacent to opposite ends of the main body, respectively, the alignment portions configured to restrict unwanted displacement of the structural profile portion when the structural profile portion is engaged with the panels;
wherein each alignment portion comprises a main body, a plug extending from a main face of the main body, and a pair of locating pins extending from two sides of the main body; the main body of the alignment portion is sized and shaped to be congruent with a size and the shape of the transverse cross section of the main body of the structural profile portion, the plug is configured to be engaged in a matching hole of the end of the structural profile portion, the pins extend from the main body of the alignment portion in a first direction and a second direction respectively, the first and second directions are perpendicular to each other, and each of the pins is configured to be engaged in a matching void of a corresponding one of the panels; and
wherein the structural profile portion and the alignment portions are formed together as a single, unitary piece of material.

24. (canceled)

25. A panel connecting system for interconnecting at least four panels, the connecting system comprising:
two structural profiles each comprising:
an elongate main body having a generally square transverse cross section; and
a pair of elongate tenons extending from two sides of the main body, respectively, each of the tenons configured for fittingly engaging in an undercut channel of a corresponding one of the panels; and
a pair of alignment means each comprising a pair of first plugs, wherein the two alignment means are configured to engage with opposite ends of the pair of main bodies, respectively, with the first plugs of each alignment means engaged in the corresponding ends of the main bodies and the two alignment means restricting unwanted displacement of the structural profiles when the structural profiles are engaged with the panels with the main bodies being juxtaposed along their lengths.

26. (canceled)

27. A panel connecting system according to claim 25, in which each alignment means further comprises two second plugs, and the two second plugs are configured for to engage in respective aligned edge portions of two of the four panels that are substantially coplanar with each other when the structural profiles are engaged with the panels with the main bodies being juxtaposed along their lengths.

28. (canceled)

29. (canceled)

30. A panel connecting system for interconnecting at least two panels, the connecting system comprising:
a structural profile comprising:
an elongate main body having a generally square transverse cross section; and
a pair of elongate tenons extending from a plurality of sides of the main body, each of the tenons configured for fittingly engaging in a mating undercut channel of a respective one of the panels;
a pair of strips of material, wherein each strip of material has a width congruent with a thickness of a same one of the panels, the strips of material are attachable to opposite edge faces of said one of the panels, respectively, such that the strips of material cover opposite ends of the undercut channel and thereby restrict unwanted displacement of the structural profile when the structural profile is engaged with said one of the panels; and
a pair of plugs each comprising an enlarged head portion, and an engaging portion extending from the head portion, the engaging portion configured to be engaged in a corresponding hollow end of the structural profile;
wherein a thickness of each strip of material is substantially the same as a corresponding thickness of each head portion.
